(19) United States
(12) Patent Application Publication
(10) Pub. No.: US 2010/0062410 A1
(43) Pub. Date: Mar. 11, 2010

(54) COMPUTERIZED TESTING DEVICE WITH A NETWORK EDITING INTERFACE

(75) Inventors: Cheng-Hui CHIANG, Kaohsiung City (TW); Chia-Lin Lu, Kaohsiung City (TW); Tzu-Yin Lu, Kaohsiung City (TW); Pei-Ching Cheng, Kaohsiung City (TW); Kuei-Yin Lin, Kaohsiung City (TW); Meng-Chieh Wu, Kaohsiung City (TW); Shu-Ching Wang, Kaohsiung City (TW); Yu-Cheng Hsiao, Kaohsiung City (TW)

Correspondence Address: RABIN & Berdo, PC, 1101 14TH STREET, NW, SUITE 500, WASHINGTON, DC, 20005, US

(73) Assignee: BAIS Education & Technology Co., Ltd., Kaohsiung City (TW)

(21) Appl. No.: 12/556,735

(22) Filed: Sep. 10, 2009

(30) Foreign Application Priority Data
Sep. 11, 2008 (TW) 097134798
Nov. 14, 2008 (TW) 097143978

(51) Int. Cl. G09B 7/00

(52) U.S. Cl. 434/322

(57) ABSTRACT

The computerized testing device with a network editing interface in accordance with the present invention allows a teacher to generate customized quizzes or teaching materials for students logging into the computerized testing device to take tests through a network. The computerized testing device comprises an examination managing module, a content database, a testing module and a recording module. The network editing interface allows teachers to generate quizzes or teaching materials, and comprises a quiz database, a template database, a teacher database and a network editing interface.

### FIELD OF THE INVENTION

The present invention relates to a computerized testing device with a network editing interface to support remote testing that provides teachers a ability to generate customized quizzes or teaching materials for students logging onto the computerized testing device to take tests through a network.

### BACKGROUND OF THE INVENTION

In recent years, educational instruction has changed greatly from conventional classroom teaching techniques. The conventional classroom teaching techniques comprise a teacher presenting information to students in an essentially non-interactive way such as a lecture. Often, a textbook or other written material is provided to students in anticipation that the students will study the written material before the teacher presents and explains the material in class. Conventional classroom education techniques still primarily use words in textbooks and lectures to communicate.

To accommodate student and teacher time and location constraints, remote study has become a desirable option for education. Networks such as the internet and local area networks (LANs) have made this possible.

However, putting written materials for remote study on a network may require extensive reproduction work such as cutting, copying, typing and scanning. Therefore, databases that store education materials for remote education and an efficient method of reproducing and digitalizing printed material are required.

Advancement of animation technology, particularly Macromedia's Flash, has created interactive animation of images. However, Flash was designed as a professional tool for artists and animators to create professional internet animations. Professional Flash animators are expensive and difficult to find. Most teachers are not sufficiently trained to create dynamic images using Macromedia's Flash. Therefore, a need for an interactive network device that uses an efficient method to build an effective remote module without having to employ highly skilled and trained specialists is also needed.

### SUMMARY OF THE INVENTION

The present invention has multiple objectives. The primary objective of the present invention is to provide a computerized testing device with a network editing interface that allows a teacher to generate customized quizzes respectively for students logging onto the computerized testing device to take tests via a network including the internet.

The second objective of the present invention is provide a computerized testing device with a network editing interface that provides teachers extensive teaching resources and a graphical user interface (GUI) that allows customized quizzes or teaching material to be created without expensive creation work.

The computerized testing device with a network editing interface in accordance with the present invention allows a teacher to generate customized quizzes or teaching materials for students logging onto the computerized testing device to take tests via a network including the internet. The computerized testing device comprises an examination managing module, a content database, a testing module and a recording module. The network editing interface allows a teacher to generate multiple unique quizzes or teaching materials and comprises a quiz database, a template database, a teacher database and an network editing interface.

### BRIEF DESCRIPTIONS OF THE DRAWINGS

FIG. 1 is a functional block diagram of a computerized testing device in accordance with the present invention;

FIG. 2 is a functional block diagram of a network editing interface of an examination managing module in FIG. 1; and

FIG. 3 is a functional block diagram of a network editing interface of the network editing interface in FIG. 2.

### DETAILED DESCRIPTION OF THE PRESENT INVENTION

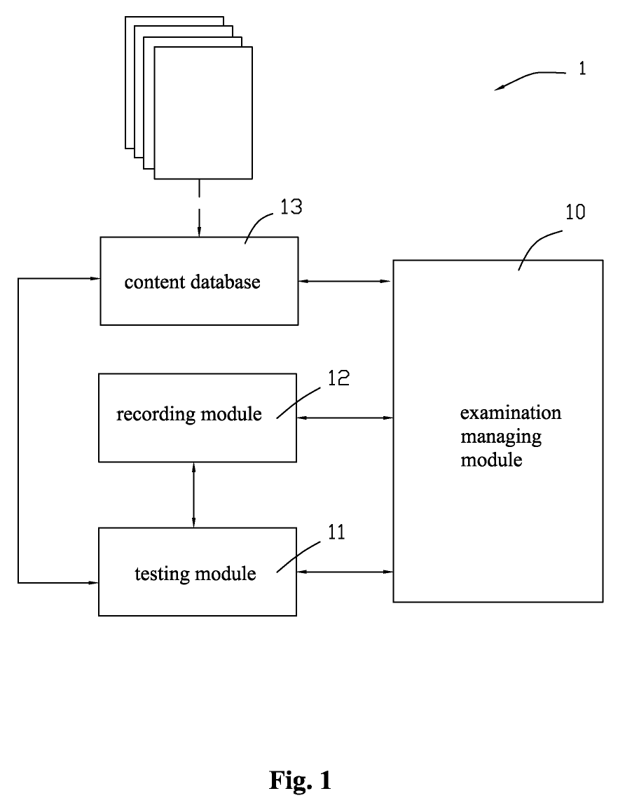

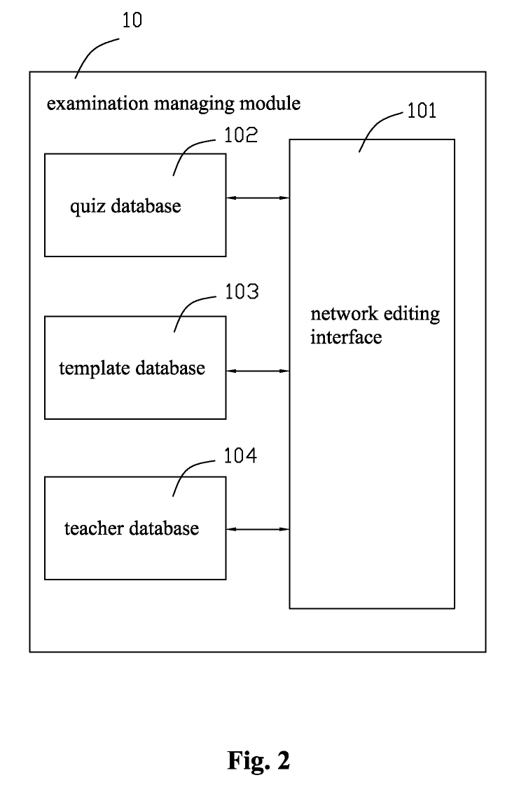

With reference to FIGS. 1 and 2, a computerized testing device (1) in accordance with the present invention uses a network editing interface (101). The network editing interface (101) allows a teacher to generate customized quizzes respectively for students logging onto the computerized testing device (1) to take tests via a network such as the internet.

The computerized testing device (1) comprises an examination managing module (10), a content database (13), a testing module (11) and a recording module (12).

The examination managing module (10) allows a teacher to login, to select a testing subject, a testing date and corresponding quizzes respectively for specific students and comprises a quiz database (102), a template database (103), a teacher database (104) and a network editing interface (101).

The quiz database (102) comprises multiple records, multiple exercises and exercise's information data. The exercises are stored respectively in the records. The exercise's information data are stored respectively in the records and comprise at least an exercise's title, subject, corresponding answer and difficulty.

The template database (103) stores multiple Flash components.

The teacher database (104) stores personal information data about specific teachers. The personal information data for each teacher comprises at least a teacher's name, account name, password and multiple template setup files. The template setup files record a teacher's editing history based on previous quiz templates generated by the teacher.

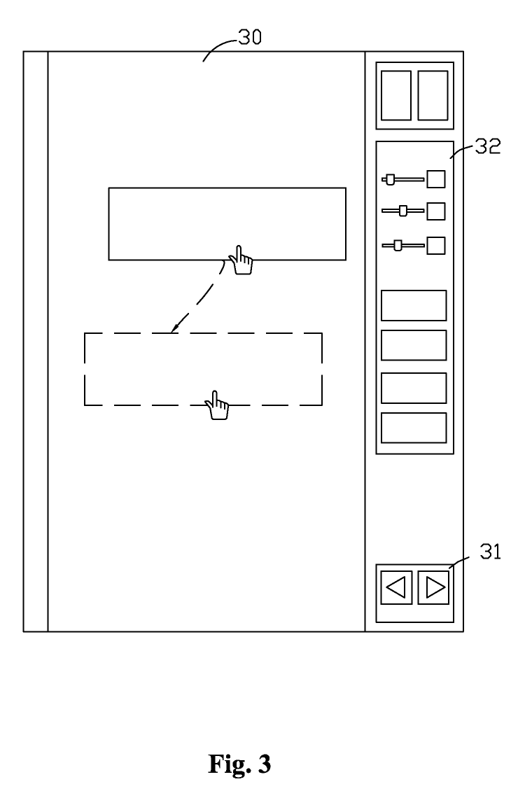

With further reference to FIG. 3, the network editing interface (101) is connected to the quiz database (102), the template database (103) and the teacher database (104), is a graphical user interface (GUI), allows a teacher to create customized quizzes by selecting exercises and Flash components based on a teacher's desired template and comprises an editing area (30), a page switch (31) and an editing menu (32). The editing interface (101) may be a web-based interface.

The editing area (30) is a “What You See Is What You Get” (WYSIWYG) typesetting area that allows the teacher to drag a selected exercise and Flash component to a desired location.

The page switch (31) allows the teacher to switch pages when customized quizzes have multiple pages, and components in the editing area change based on current page.

The editing menu (32) has multiple options such as font type, font size, save and print. The save option allows the teacher to save a finished customized quiz or print the finished customized quiz to an external printer.

The finished customized quiz has two types. One type of the finished customized quiz is a student version. Another type of the finished customized quiz is a teacher version that has exercises and corresponding detail answer explanations.

The content database (13) is connected to the examination managing module (10) and comprises multiple records, multiple quizzes and personal information data about specific students. The quizzes are stored respectively in records in at least one file format. The at least one file format may be selected from Word, text, numerical, date or data files. The data files of the quizzes may be Flash data format. The personal information data for each student comprises at least the student's name, account name, password, grade and academic history.

Furthermore, the examination managing module (10) further comprises a quiz filtering module. The quiz filtering module uses multiple predefined selection methods to help a teacher to select quizzes and comprises a subject selection method, a criteria selection method, a uni-format selection method and a history selection method.

The subject selection method allows a teacher filtering out desired exercises randomly based on a particular subject from the quiz database.

The criteria selection method allows a teacher filtering out desired exercises randomly based on the teacher's criteria from the quiz database such as difficulties of exercises.

The uni-format selection method allows a teacher filtering out non-customized quiz directly from the content database for a particular purpose such as a final examination for whole students.

The history selection method allows a teacher filtering out a previous quiz from the content database, and the previous quiz may created by another teacher.

The testing module (11) is connected to the examination managing module (10) and the content database (13), is a network GUI and allows the student to login to the computerized testing device (1) and take tests based on arrangements of the examination managing module (10).

The recording module (12) is connected to the examination managing module (10), content database (13) and the testing module (11), retrieves a specific student's academic history into the examination managing module (10) that gives a teacher information about the student's academic performance, records responses of the student in the content database (13) when the student is taking a test in the testing module (11) and allows a teacher to record a test result in the content database (13) when the student takes a hard copy test.

However, the foregoing description about the network editing interface in the detail description is only an example of generating quizzes. The networking editing interface can be also used to generate customized teaching materials with required teaching contents stored in the quiz database. People skilled in the art will understand that various changes, modifications and alterations in form and details may be made without departing from the spirit and scope of the invention.

What is claimed is:

1. A computerized testing device with a network editing interface comprising
an examination managing module allowing a teacher to login, select a testing subject, a testing date and corresponding quizzes respectively for specific students and comprising
a quiz database comprising
multiple records;
multiple exercises being stored respectively in the records; and
exercises' information data being stored respectively in the records and comprising at least an exercise's title, subject, corresponding answer and difficulty;
a template database storing multiple Flash components;
a teacher database storing personal information data about specific teachers, and the personal information for each teacher comprising at least
a teacher's name;
account name;
password; and
multiple template setup files recording a teacher's editing history based on previous quiz templates generated by the teacher; and
a network editing interface being connected to a network, a teacher's interface, the quiz database, the template database and the teacher database, being a graphical user interface (GUI), allowing a teacher to create customized quizzes by selecting exercises and Flash components based on a teacher's desired template and comprising
an editing area being a “What You See Is What You Get” (WYSIWYG) typesetting area that allows the teacher to drag a selected exercise and Flash component to a desired location;
a page switch allowing the teacher to switch pages when customized quizzes having multiple pages and components in the editing area change based on current page; and
an editing menu having multiple options allowing teacher to save a finished customized quiz or print the finished customized quiz to an external printer;
a content database being connected to the examination managing module and comprising
multiple records;
multiple quizzes being stored respectively in records in at least one file format; and
personal information data about specific students comprising at least the student's name, account name, password, grade and academic history;
a testing platform being connected to the examination managing module and the content database, being a network GUI and allowing the student to login to the computerized testing device and take tests based on arrangements of the examination managing module; and
a recording module being connected to the examination managing module, content database and the testing module, retrieving a specific student's academic history into the examination managing module that gives a teacher information about the student's academic performance, recording responses of the student in the content database when the student is taking a test in the testing module and allowing a teacher to record a test result in the content database when the student takes a hard copy test.

2. The computerized testing device with a network editing interface as claimed in claim 1, wherein the at least one file format of the content database is selected from a group consisting of Word, text, numerical, date and data files.

3. The computerized testing device with a network editing interface as claimed in claim 1, wherein the examination managing module further comprising
a quiz filtering module use multiple predefined selection methods to help a teacher to select quizzes and comprising
a subject selection method allowing a teacher filtering out desired exercises randomly based on a particular subject from the quiz database;
a criteria selection method allowing a teacher filtering out desired exercises randomly based on the teacher's criteria from the quiz database;
a uni-format selection method allowing a teacher filtering out non-customized quiz directly from the content database for a particular purpose; and
a history selection method allowing a teacher filtering out a previous quiz from the content database.

4. The computerized testing device with a network editing interface as claimed in claim 1, wherein the editing interface is a web-based interface.

5. The computerized testing device with a network editing interface as claimed in claim 2, wherein the data files of the quizzes are in Flash data format.

6. A network editing interface allows a teacher to create customized teaching materials by selecting teaching content and Flash components based on a teacher's desired template, is connected to a quiz database consisted of at least multiple teaching contents and a template database consisted of at least multiple Flash components, and the network editing interface comprising
an editing area being a WYSIWYG typesetting area that allows the teacher to drag a selected teaching content and Flash component to a desired location;
a page switch allowing the teacher to switch pages when customized quizzes having multiple pages and components in the editing area change based on current page; and
an editing menu having multiple options allowing teacher to save a finished customized quiz or print the finished customized quiz to an external printer.

7. The network editing interface as claimed in claim 6, wherein the editing interface is a web-based interface.
